(19) United States
(12) Patent Application Publication
(10) Pub. No.: US 2025/0326102 A1
(43) Pub. Date: Oct. 23, 2025

(54) HAND TOOL

(71) Applicant: GUSTAV KLAUKE GMBH, Remscheid (DE)

(72) Inventor: Egbert FRENKEN, Heinsberg (DE)

(73) Assignee: GUSTAV KLAUKE GMBH, Remscheid (DE)

(21) Appl. No.: 18/871,344

(22) PCT Filed: Jun. 12, 2024
(86) PCT No.: PCT/EP2023/065652

§ 371 Date: Dec. 3, 2024

(30) Foreign Application Priority Data
Jun. 10, 2022 (DE) 10 2022 114 709.6
Oct. 25, 2022 (DE) 10 2022 128 186.8

(51) Int. Cl. B25F 5/00; B25B 27/14

(52) U.S. Cl. CPC B25F 5/005; B25B 27/146

(57) ABSTRACT

A hand tool includes an actuator and a moving part. The actuator drives the moving part directly or via a gearbox or by a hydraulic medium for performing an intended operation, with a chamber formed in the hand tool, in which an air volume with an air pressure is or can be enclosed. The air pressure can be changed and evaluated for acquiring a state of the hand tool. The operation can be performed independently of the air pressure that develops in the chamber.

### AREA OF TECHNOLOGY

A hand tool with an actuator and a moving part is described and explained, wherein the actuator drives the moving part directly or via a gearbox or by a hydraulic medium for performing an intended operation, with a chamber formed in the hand tool, in which an air volume with an air pressure is or can be enclosed.

### PRIOR ART

Hand tools of the kind in question are known in a variety of designs. For example, the latter are used for pressing, cutting, punching, crimping, or, for example, solely for capturing tools, wherein work is most often performed indirectly or directly against a fixed part on the tool side via the moving part, with the workpiece to be machined being placed in between. For this purpose, the moving part is indirectly or directly moved out of a movement start position in the direction toward a movement end position via an actuator, wherein the actuator can be an electric motor that acts with the interposition of a gearbox and/or via a hydraulic medium. For example, the actuator can also be a movable hand lever, which can act directly or indirectly on the moving part, for example via a hydraulic medium.

With respect to a hand tool designed as a hydraulically acting pressing tool, reference is exemplarily made to WO 03/084719A2 (U.S. Pat. No. 7,254,982 B2), EP 1 084 798 B1 (U.S. Pat. No. 6,718,870 B2), WO 2014/009363 A1 (US 2015/0251256 A1) or also to WO 2020/053101 A1 (US 2021/0339367 A1), and further exemplarily also to WO 2021/069587 A1 or to DE 10 2013 101 978 A1. For example, a hand tool designed as a pressing tool with an electric motor that acts on the moving part via a gearbox is known from DE 10 2014 100 348 A1. A pincer type hand tool is further exemplarily known from WO 2019/219407A1 (US 2021/0296837A1).

The contents of the aforementioned patent specifications and patent applications are hereby fully incorporated into the disclosure given here, including for the purpose of incorporating features of these patent specifications and patent applications into claims of the present solution.

As known from the prior art cited for the pressing devices, a return spring that loads the moving part, for example in the direction toward the movement start position, can be arranged in a chamber situated in the hand tool.

### SUMMARY OF THE SPECIFICATION

The object is to improve the design of a hand tool of the kind in question with respect to handling safety.

In a first possible solution to the object for a hand tool, emphasis is placed on the ability to change the air pressure and evaluate it for acquiring a state of the hand tool, wherein the operation can be performed independently of the air pressure that develops in the chamber.

During the displacement of the moving part from the movement start position in the direction toward the movement end position, but also additionally or alternatively possibly during the displacement of the moving part from the movement end position back in the direction toward the movement start position, a change in air pressure may arise in the chamber. By evaluating the actual air pressure, preferably as a function of at least one stored target air pressure, knowledge can be gained about the state, for example the functionality, of the hand tool. Furthermore, such comparisons with stored target values can also take place during the displacement of the hand tool in various moving part positions.

In order to perform a safety check on the hand tool before the hand tool is used, for example, the air pressure in the chamber can additionally be changed even without displacing the moving part—and thus without using the hand tool as such, for example using a separate apparatus, further for example in the form of an air pump, wherein the apparatus for changing the air pressure is connected to the chamber.

An evaluation of the air pressure change in the chamber can result in an adjusted display for the user. In the simplest form, this can be an indicator which becomes visible to the user during the change in air pressure. For example, an analog or digital display can further be provided, which possibly displays only two possible states, or also any change in air pressure, for example given a digital pressure value display. Other optical and/or acoustic signals can potentially also be triggered as a function of a change in air pressure.

In addition, data about the acquired changes in air pressure can also be stored in a possibly provided data memory of the hand tool, or also on an external data memory, to which the data can be transmitted, for example via radio.

The air pressure to be achieved in the chamber and acquirable in the process does not contribute to the developing force that acts on the workpiece during operation of the hand tool. The operation is also performed independently of the air pressure that is potentially generated in the chamber while performing the operation. The air pressure can even tend to form a counterforce, but it is clearly subordinate to a driving force which the actuator develops for performing the operation. The pressure values that can be reached in the chamber are preferably so low as to be inadequate for initiating the pressing or cutting of a workpiece, or significantly supporting this process.

Additional features are often described below—including in the figure description—in their preferred allocation to the basically described solution or to additional features. However, they can also be significant as allocated to only individual, already described features or to the respective further described feature, or each independently of each other.

In a possible embodiment, a pressure sensor is provided for measuring the air pressure in the chamber. An air pressure measured by such a pressure sensor can be evaluated to acquire the state of the hand tool. Conclusions can be drawn via such a measurement evaluation, for example relating to safety aspects.

The pressure sensor can be directly arranged on the chamber, facing the interior of the chamber.

The change in air pressure can be generated by changing a size of the chamber. Such a change in chamber size can be directly related with the displacement of the moving part, in particular in those configurations where a portion of the moving part is designed as a piston that can be moved during displacement in the chamber. In particular as the moving part is being displaced from the movement start position in the direction toward the movement end position, the piston section moving in the chamber produces a successive reduction in chamber size.

The change in air pressure in the chamber can also be generated by changing the quantity which means the volume of air enclosed in the chamber. For example, the air pressure in the chamber can be changed without any travel by the moving part by connecting a pump or a compressor to the chamber. For example, such a change in air quantity makes it possible to perform a safety check with the hand tool in an idle state.

Furthermore, the change in air pressure can arise with the initiation or performance of the operation, accordingly while using the hand tool, thereby possibly also enabling a safety-relevant monitoring during the operation by acquiring and evaluating the air pressure that develops in the chamber.

The chamber can have a pneumatic sensor in the form of a sealable opening. Such an opening can be separate to any other openings, for example through which a portion of the moving part exits outwardly as viewed from the chamber, or also to an opening through which the moving part is acted upon inside of the chamber.

The sealable opening of the chamber can be a relevant part for acquiring the state of the hand tool. The seal can be formed by separate apparatus that are not directly required for performing the operation, or also by one or several parts or sections of the hand tool itself. A closure of the opening can also be brought about by the user themselves while operating the hand tool.

Another embodiment can provide that the opening be connected with the chamber by an airway. This makes it possible to achieve a local separation between the chamber and opening. The airway can be provided by a channel incorporated into the hand tool, or also by a hose laid in the hand tool, for example.

In addition, several such openings can be provided in the hand tool, which are all connected with the chamber by airways. This makes it possible to monitor various safety-relevant areas of the hand tool by acquiring the air pressure values just in the (for example, only one) chamber.

In a possible embodiment, the hand tool can have a tool which can be displaced from an opening position, in which the tool can be placed in the hand tool, into a mounting position, in which the tool is secured in the hand tool. For example, this case can involve a hand tool in the form of a pressing tool, further for example in the form of a pressing tool according to WO 2020/053101 A1 (US 2021/0339367 A1), which has a relocatable bolt for swivelably holding a pair of pressing jaws, further for example a pair of pressing jaws according to DE 10 2005 028 083 B4 (US 2006/0000072 A1). In order to safely handle such a hand tool, it is required that the bolt assume the intended holding position.

In this regard, it can be provided that the mentioned opening of the chamber be sealable by displacing the bolt into the holding position. As a result, the chamber is generally sealed by the bolt in the holding position of the bolt. Conversely, this apparatus that the chamber is generally connected with the ambient pressure via the opening if the bolt has not been displaced into the intended holding position.

Only after the bolt has been displaced into the holding position is the chamber sealed away from the ambient pressure, so that the air pressure can be increased. This increase in air pressure can be achieved by reducing the chamber volume during the relocation of the moving part. Alternatively, however, also by changing the quantity of air in the chamber, as a result of which a safety check can be carried out with a pump before performing an operation, for example.

For example, the increase in air pressure in the chamber can be considered as a displacement of the bolt into the holding position. A corresponding result can be displayed optically and/or acoustically. An electronic controller of a motorized hand tool can also be used to only release the drive once the increase in air pressure to be attributed to the intended position of the bolt has been acquired (if necessary in a predetermined target value).

In an alternative or also combined embodiment, the hand tool can also have a finger-actuated switch on a first handle. In particular in electric motor-driven hand tools, such a switch serves to close a circuit used to supply the electric motor for relocating the moving part. The first handle provided here can be formed directly by the housing of the hand tool.

The switch can have an opening that is connected with the chamber via an airway. The opening is directed toward the environment, and correspondingly can visibly and accessibly open into the switch actuating surface.

The opening in the switch can be sealed in an advantageous and easy to handle manner by a switch-actuating finger. Accordingly and as also described above, the chamber generally becomes sealed only once the opening of the switch has been sealed by a finger, as a result of which the air pressure in the chamber can be raised.

As a consequence, an increase in pressure can be considered as an actuation or a readiness for actuation of the switch by a finger. Therefore, the proper placement of a hand (the guiding and operating hand) of the user on the first handle having the switch can be determined to increase operational safety.

If the finger is lifted from the switch while using the hand tool, the release of the opening causes the pressure to drop toward ambient pressure. A prescribed air pressure can no longer be built up in the chamber, which prompts an evaluation and control unit to immediately deactivate (e.g., at least within about 1/10 of a second) the drive (actuator), and hence to interrupt the operation.

As an alternative to or in combination with one or several of the previously described arrangements of chamber openings or the previously described arrangement of pneumatic sensors, the hand tool can also be provided with a separately applied label according to another possible embodiment. For example, this case can involve a safety label, e.g., which further covers the access to a screw plug of a hand tool housing or a maintenance opening, or also an information sticker.

A pneumatic sensor can be formed below the label (in the housing) in the form of an opening for air to pass through. Such an opening can also be connected with the chamber via an airway. The air pressure can be raised by sealing the opening by the label, both as the result of a decrease in the chamber size and alternatively an increase in the quantity of air in the chamber.

In the described solution, the acquired pressure increase is regarded as the label being present as intended on a previously described housing location, as a possible consequence of which the hand tool is usable/activatable. By contrast, if such a pressure increase is not acquired, it must be assumed that the opening was released by the removal or destruction of the label. The hand tool can then not be operated as intended. For example, a possible evaluation and control unit interrupts the actuation of a drive (actuator), so that the hand tool cannot be put into operation.

As an alternative or in combination with one or several of the previously described arrangements of chamber openings, the hand tool can further have a second handle according to a possible embodiment. If need be, such a second handle can be a handle that can be screwed to the hand tool, which can potentially extend transverse to a main extension axis of the hand tool.

In such an embodiment, the chamber in both handles can open into a respective opening arranged in an area of the respective handle that is usually gripped by a hand or covered by it during actuation of the hand tool. For example, the opening in the area of the first handle can here be the previously described opening in the switch.

Accordingly, a dual safety query results in this regard. The air pressure can only be raised by sealing both openings. Already the release or non-closure of just one opening allows no increase in air pressure in the chamber, which leads to an interruption of the drive (actuator) by a possible evaluation and control unit, for example.

Therefore, the pressure increase is regarded as the second handle having been gripped by one hand accompanied by the switch having been actuated by a finger of the other hand. Such a solution is suitable in particular in the case of hand tools for which two-handed operation is preferred or even prescribed for safety reasons.

As an alternative to or in combination with one or several of the previously described arrangements of chamber openings, the hand tool can further be provided with a tool holder made out of a metal material according to a possible embodiment. For example, this case can involve an electric motor-drive pressing tool, further for example a pressing tool of the kind shown and described in the EP 1 084 798 B1 cited at the outset.

Such tool holders can be subjected to very large forces during a pressing process, which can result in the tool holder being exposed to a corresponding load over a considered service life.

In order to enable the performance of a safety query here as well, the tool holder has an airway formed by the metal material itself. While manufacturing the tool holder, an airway is correspondingly left inside of the material, for example as a channel. In particular, the latter crosses (at least) one critical area of the tool holder, an area in which experience or calculations show that the high loads that arise during the operation can impair the use of the tool holder, and hence of the entire hand tool.

The released airway is connected with the chamber in the hand tool. In the intended state of the tool holder, no opening to the environment is developed by the integrated airway, so that the chamber is generally sealed. An increase in pressure during the actuation of the hand tool or during a test, for example by a connected pump, is correspondingly considered as an intact tool holder.

By contrast, a drop in pressure (during the operation) or an evaluation that no pressure can be built up is regarded as a crack in the tool holder. The crack yields an outward opening to the environment. The chamber is not sealed to enable a pressure buildup.

### BRIEF DESCRIPTION OF THE DRAWINGS

While the described solution is explained below based upon the attached drawing, the latter only depicts exemplary embodiments. Therefore, a part that is described only in relation to one of the exemplary embodiments and is not replaced by a different part in another exemplary embodiment due to the feature highlighted therein is also described as a part that can in any event be present even for this other exemplary embodiment. The drawing shows:

FIG. 1 a partially cut perspective view of an electric motor-driven hand tool in a first embodiment;

FIG. 2 the schematically depicted section in sectional plane II in FIG. 1;

FIG. 3 the longitudinal section in sectional plane III in FIG. 1 through a working head of the hand tool according to FIG. 1 having a bolt;

FIG. 3a a view according to FIG. 3, with an independent operating part;

FIG. 3b an enlargement of FIG. 3a;

FIG. 4 a perspective view of the working head;

FIG. 5 a magnification of area V in FIG. 1;

FIG. 6 a schematic view of the working head with a moving part in a movement start position;

FIG. 7 a view corresponding to FIG. 6, relating to an intermediate position while the moving part is traveling, with the bolt in a holding position;

FIG. 8 a schematic view according to FIG. 7, but with the bolt in an opening position;

FIG. 9 an air pressure measurement diagram;

FIG. 10 a schematic view according to FIG. 6, relating to an alternative design;

FIG. 11 the bolt area of the working head in an alternative embodiment;

FIG. 12 a partially cut side view of a hand tool, relating to another embodiment;

FIG. 13 a sectional view of the working head of the hand tool according to FIG. 12;

FIG. 14 another partially cut side view of a hand tool in another embodiment;

FIG. 15 a side view of a hand tool in another embodiment;

FIG. 16 a schematic view of a hand tool in another embodiment;

FIG. 17 a view of a hand tool in another embodiment;

FIG. 18 a schematic longitudinal sectional view of a hand tool in another embodiment;

FIG. 19 a schematic view presentation of a hand tool in another embodiment, relating to a movement start position of a moving part;

FIG. 20 a view corresponding to FIG. 19, relative to a movement end position of the moving part.

### DESCRIPTION OF THE EMBODIMENTS

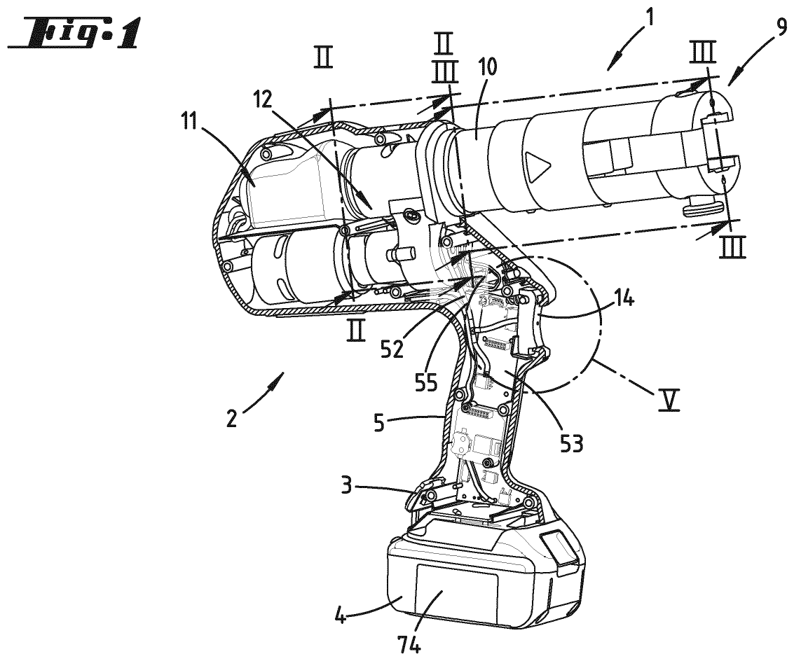

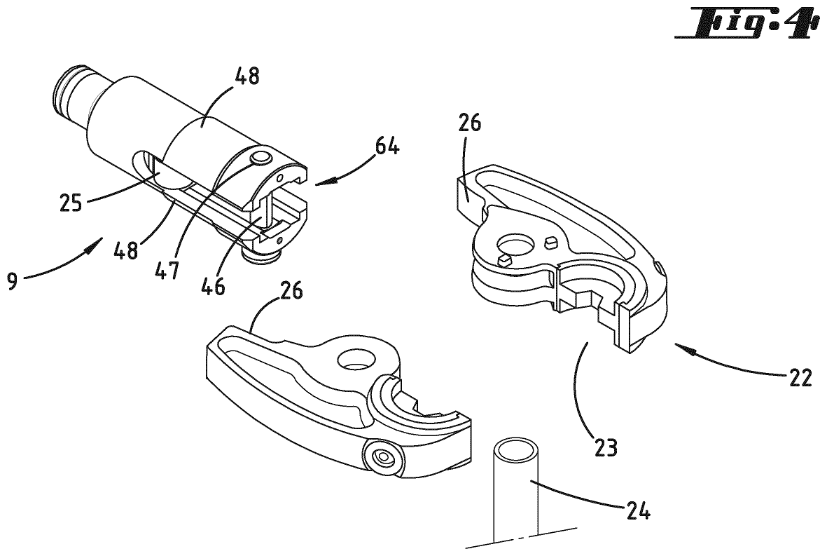

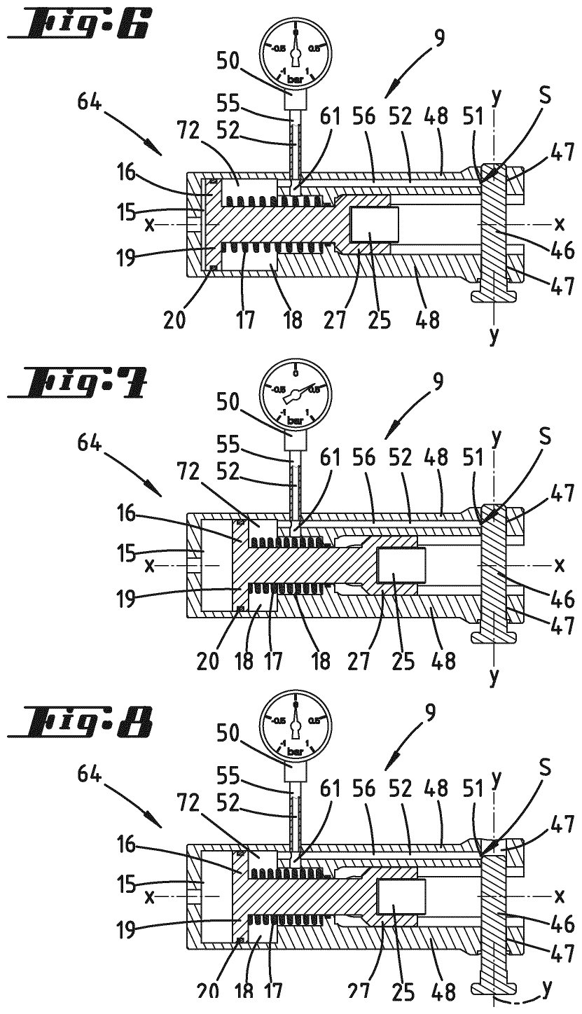

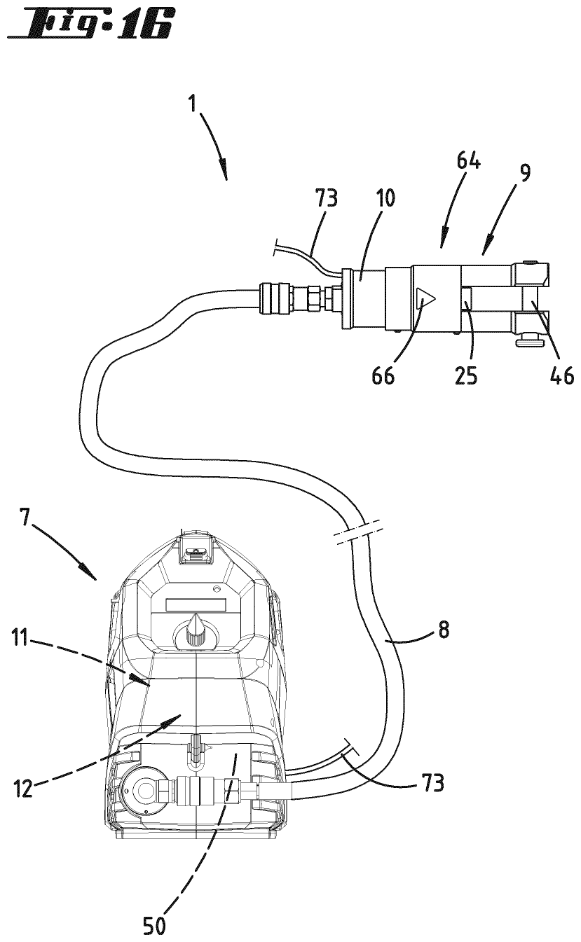

The figures described below show various possible embodiments of a hand tool 1, wherein FIGS. 1 to 9 relate to a first embodiment with alternative configurations according to FIGS. 10 and 11, FIGS. 12 and 13 to a second possible embodiment, and FIG. 14 to a third embodiment, with FIGS. 15 to 20 showing additional exemplary embodiments. Other alternative embodiments are also possible apart from the above, so that FIGS. 1 to 20 must here not be construed as limiting, but rather serve to explain the possible features.

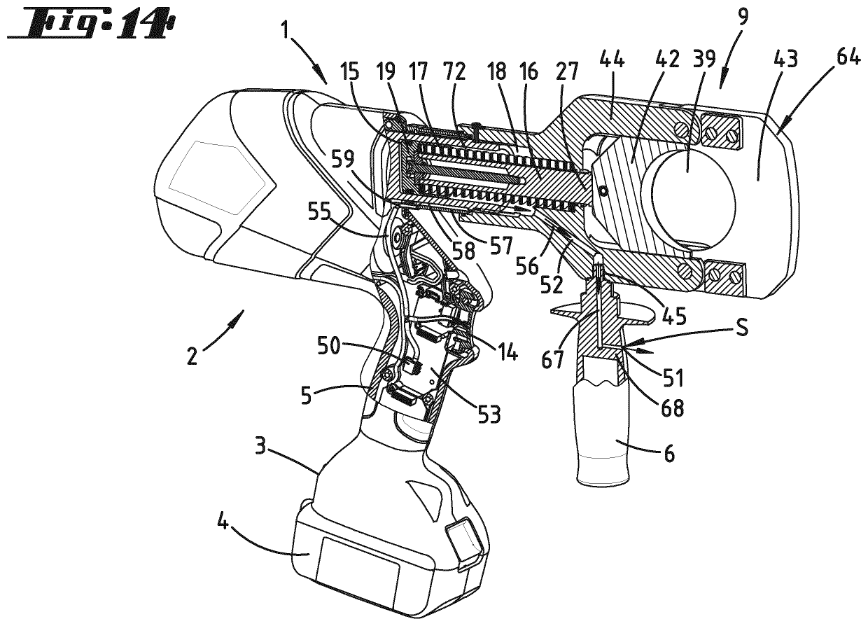

The hand tool 1 shown among other places in FIG. 1 in the first embodiment, but further also in FIGS. 12 and 14 in additional embodiments, can have a pistol-shaped basic tool base 2 forming a tool housing. Alternatively, the basic tool base 2 according to FIG. 15 can also be elongated and rod-shaped in design.

The hand tool 1 is here exemplarily a hydraulically actuatable pressing or crimping tool. Alternatively, however, the hand tool 1 can also be modified in such a way as to serve other purposes, for example for cutting (as exemplarily shown in FIG. 14) or punching workpieces.

The basic tool base 2 further has a handle 5 that is aligned generally transverse to a geometric longitudinal axis x of the basic tool base 2, with which a user can guide the hand tool 1. If operation is to be wireless, a power source in the form of an accumulator 4 is arranged at a free end piece 3 of the handle 5 for supplying power to the hand tool 1. Alternatively, the power source may include an electric cable that can be used to establish a connection to a power supply via an electric network.

In addition to the handle 5 of the basic tool base 2, the hand tool 1 can have yet another second handle 6 shown in FIG. 14, for example, so that especially heavy hand tools 1 can be safely guided and held, in particular if the weight makes onehanded operation impossible.

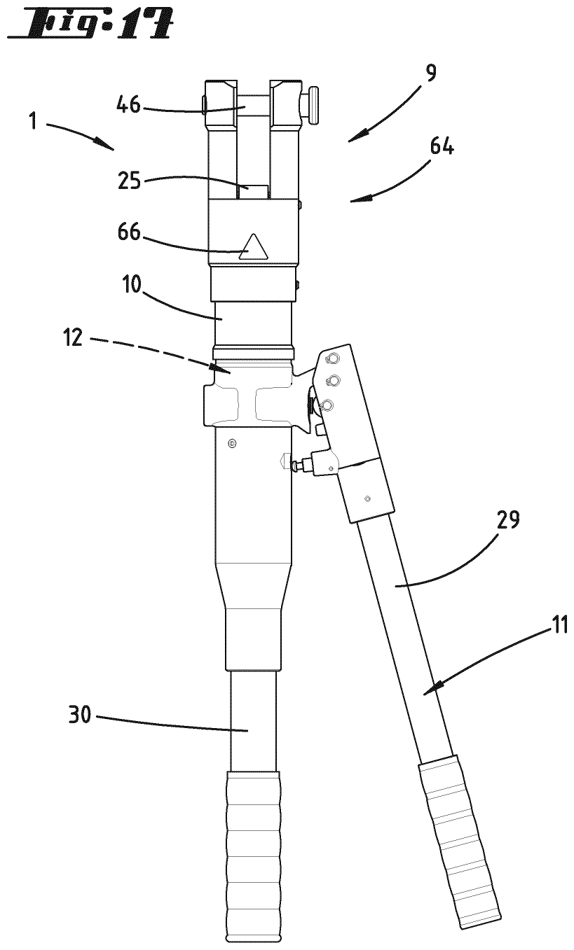

Within the framework of the solution described here, the hand tool 1 can also be designed in particular to have a separately provided actuator 7, in particular a separate power supply device and/or a separately provided hydraulic pump, which is connected with a working head 9 of the hand tool 1 via a hydraulic hose 8 (see FIG. 16).

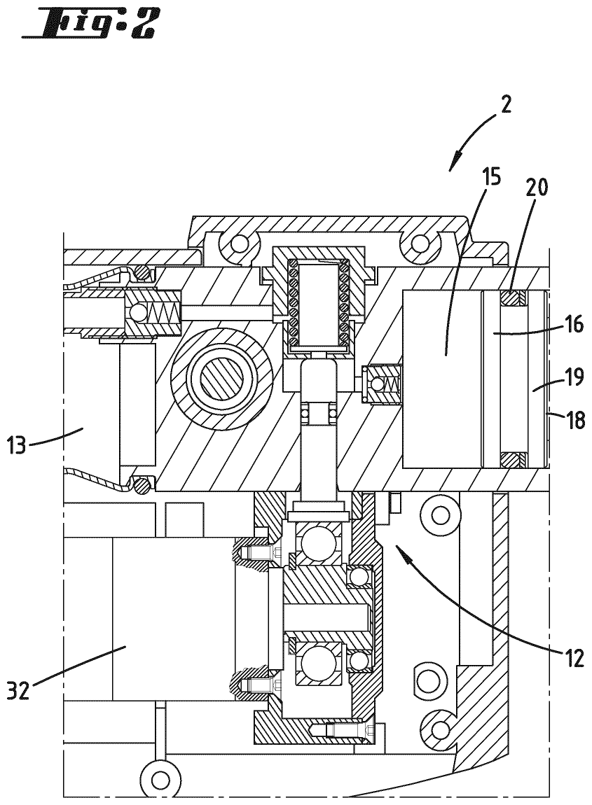

In the embodiments depicted according to FIGS. 1 to 15, a working head 9 or a tool holder 64 of the hand tool 1 is connected via an adapter 10 with an actuator 11 in the form of a hydraulic actuator 12, which is integrated into the basic tool base 2 of the hand tool 1 (see also FIG. 2). The tool holder 64 is preferably made out of metal.

Part of the hydraulic actuator 12 can be an electric motor 32, which can be driven via the exemplarily provided accumulator 4. Upon actuation of a finger-actuated switch 14 arranged in the first handle 5, hydraulic fluid (oil) is pumped out of a hydraulic tank 13 into a hydraulic space 15 via a pump, for example a piston pump, as a result of which a piston-like moving part 16 displaceably incorporated into the hydraulic space 15 is moved in the direction of a movement end position.

The moving part 16 can be exposed to the action of a return spring 17, which surrounds the moving part 16 in the area of a piston shaft section. The return spring 17 can sit in a chamber 18 defined by a cylindrical chamber wall, and here be supported with one end area on a chamber floor and with the opposite end on a piston section 19 of the moving part 16 that simultaneously extends into the chamber 18.

The piston section 19 can peripherally carry a radial gasket 20. The radial gasket 20 tightly seals the hydraulic space 15 created behind the moving part 16 in relation to the chamber 18 that guides the moving part 16 or in relation to a pneumatic space 72 that arises facing away from the hydraulic space 15.

As also shown, a working head 9 or a tool holder 64 can be interchangeably held on the cylindrical chamber wall defining the chamber 18. The working head 9 or tool holder 64 can be rotated around the geometric longitudinal axis x directed in the piston displacement direction in order to make convenient adaptations to local circumstances.

A pair of compression jaws 22 swivelable around an axis y transverse to the longitudinal axis x can be arranged on the working head 9 according to the illustrations in FIGS. 1 to 11. These compression jaws 22 can be swiveled out of a spaced apart open position into a closed position in order to compress a pellet 24 inserted into a pressing mouth 23 that results between the compression jaws 22.

For this purpose, the moving part 16 on a tool carrier 27 can carry impact rollers 25, which during the linear displacement of the moving part 16 from the movement start position in the direction of the movement end position travel along running surfaces 26 of the compression jaws 22, using them to control the swiveling of the compression jaws 22.

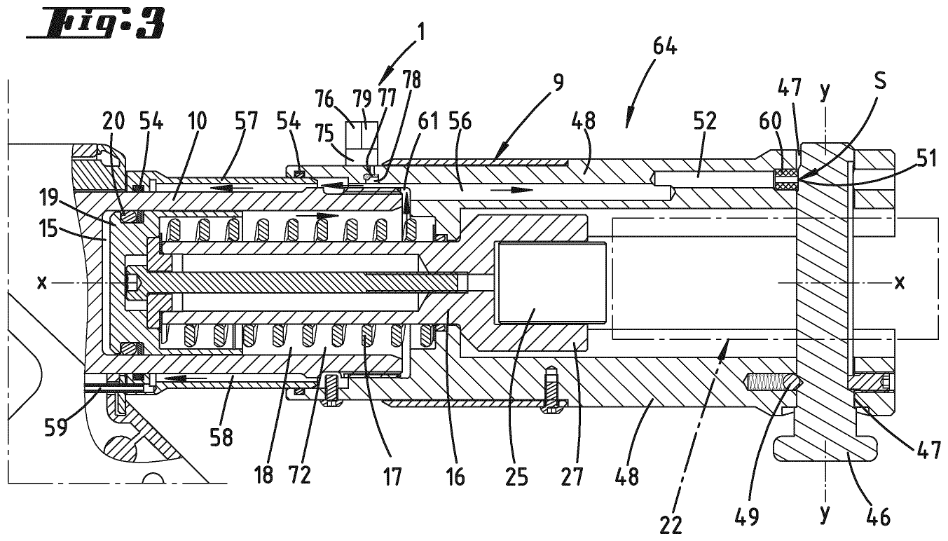

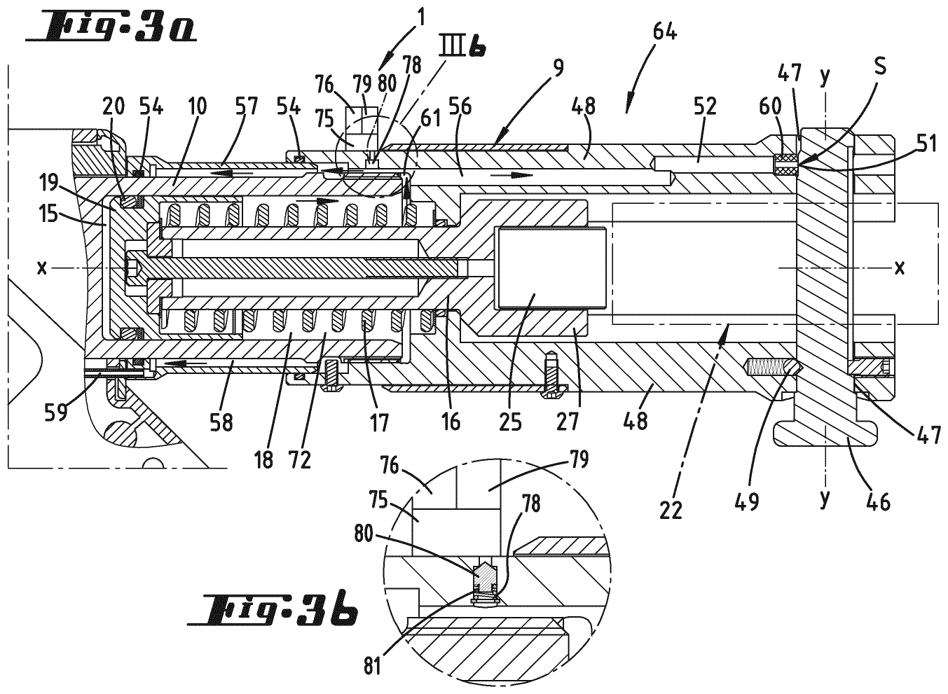

The compression jaws 22 can be swivelable around a bolt 46 that extends along the geometric axis y, wherein this bolt 46 is supported at roughly the respective end in boreholes 47 of two fork legs 48 of the working head 9 in an intended holding position, for example according to FIG. 3.

For example, the holding position can be secured by a latching ball 49.

Linearly displacing the bolt 46 along the axis y allows the bolt 46 to be moved into an opening position, in which the removal of the compression jaws 22 or an assembly with the compression jaws 22 can be performed.

By pumping hydraulic fluid into the hydraulic space 15, the moving part 16, and thereby the tool carrier 27 with its impact rollers 25, is advanced against the return force of the return spring 17.

For example, the return movement of the moving part 16 takes place solely due to the return force of the return spring 17, wherein the hydraulic fluid flows out of the hydraulic space 15 and back into the hydraulic tank 13 via the moving part 16 while opening a return valve (not shown).

According to the embodiment in FIG. 16, the hydraulic tank 13 can be provided in an external actuator 7. In this case, the hydraulic tank 13 is connected with the hydraulic space 15 via a hydraulic hose 8.

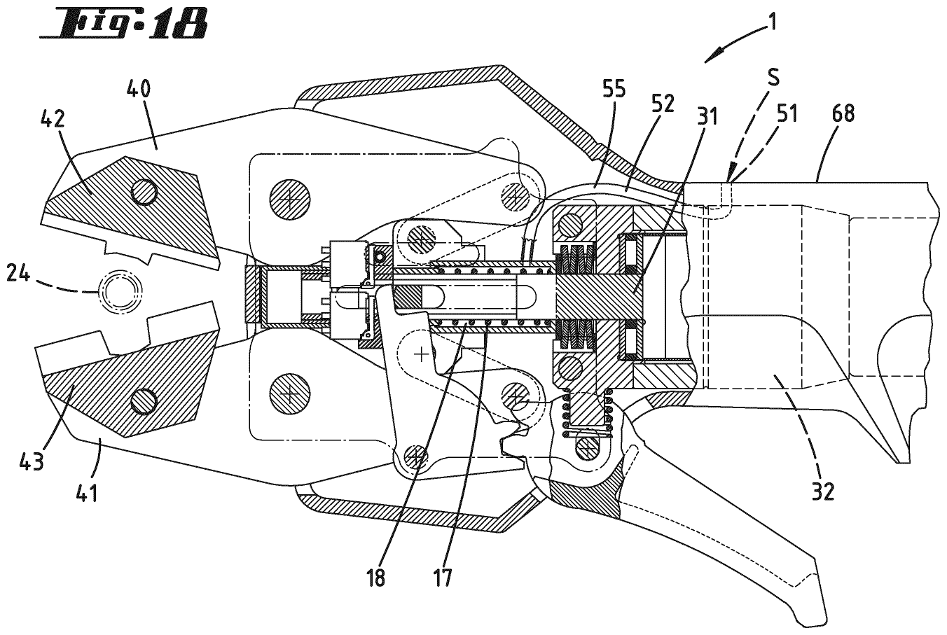

In the embodiment according to FIG. 17, an electric motor drive is not provided for conveying the hydraulic fluid. Rather, the actuator 11 is here a stem-type hand lever 29, which can be swiveled relative to a fixed hand lever 30 and the hydraulic actuator 12 fixed thereon.

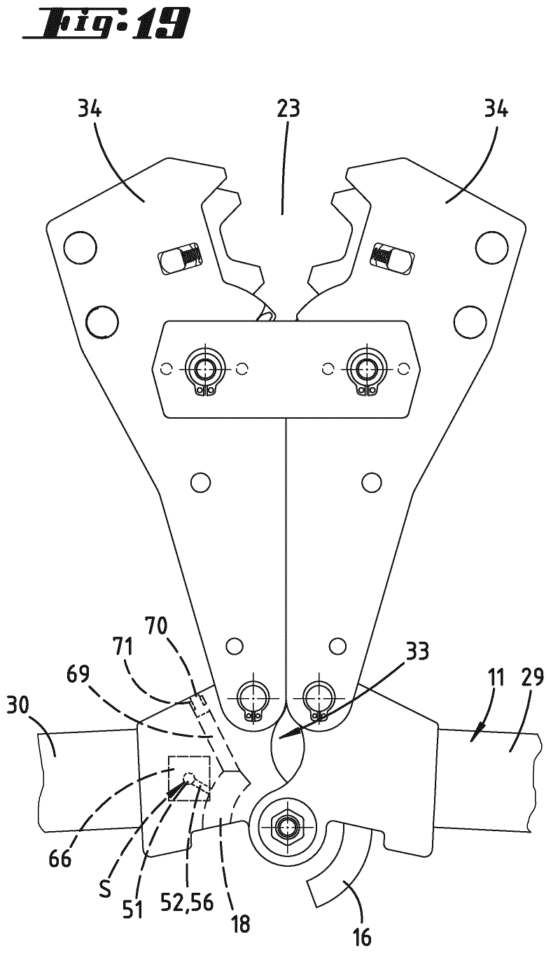

A spindle drive 31 according to the embodiment in FIG. 18 can also be provided instead of a hydraulic actuator. Here as well, the drive works against the force of a return spring 17 incorporated into a chamber 18. The spindle of this spindle 3 can be regarded as an example for a gearbox. The spindle works together with a spindle nut which will transfer the movement of the moving part. The spindle itself can be turned directly by an electric motor. For further details is also referred to the already mentioned WO 2014/009363 A1 (US 2015/0251256 A1).

A spindle of the spindle drive 31 is driven via an electric motor 32 by actuating a switch.

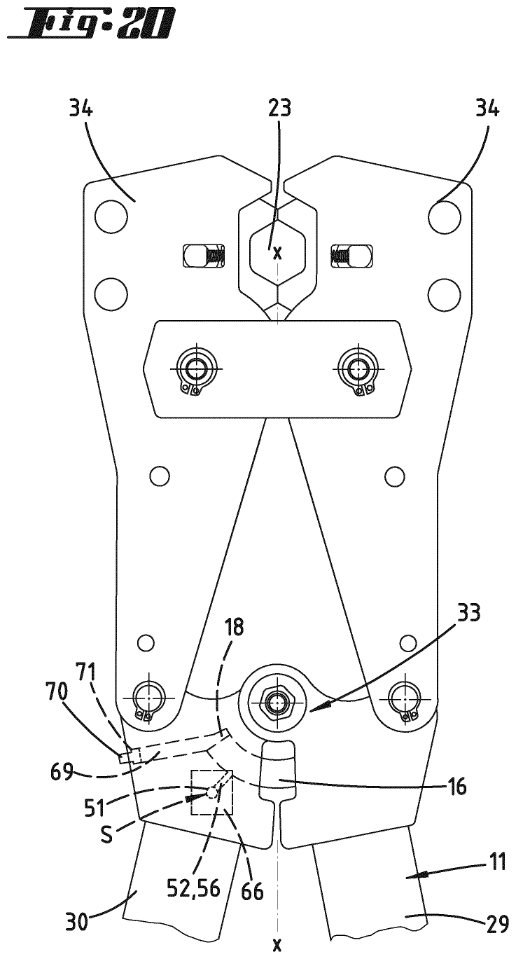

In addition, the hand tool 1 according to FIGS. 19 and 20 can also be a pincer-like tool to be operated strictly manually, for example for compressing a pellet, as shown.

A handgrip 29 that can be swiveled like a pincer toward another handgrip 30 here also serves as the actuator 11. A hinged formation 33 is here used to move two pressing jaws 34 toward each other while closing a pressing mouth 23.

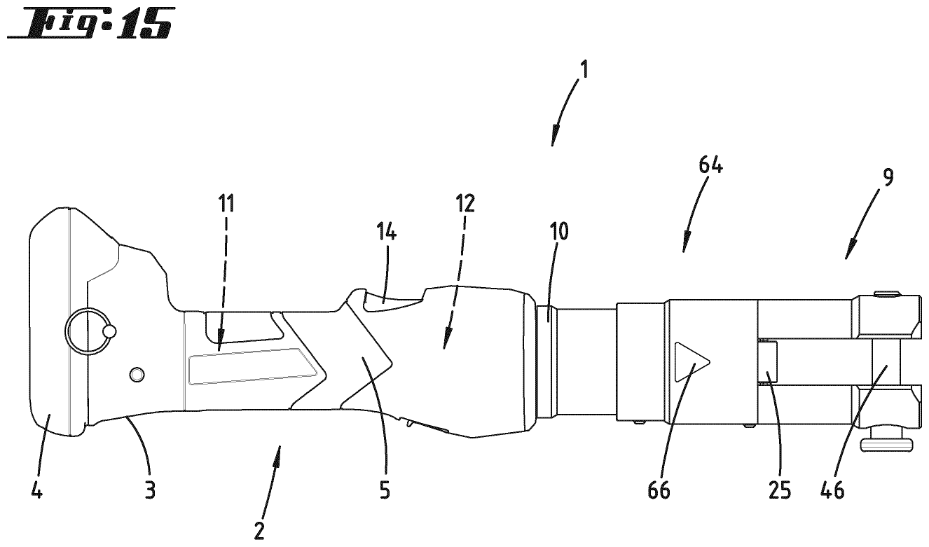

According to the illustrations in FIGS. 12 and 13, the working head 9 or the tool holder 64 of the hand tool 1 can have a holding body 35 with an integral, one-piece design. With respect to a side view according to FIG. 12 or FIG. 13, in which a longitudinal axis x of the hand tool 1 or the tool holder 64 is represented as a line, the holding body 35 can have a generally C-shaped design as a whole. The holding body 35 here has a first C-leg 36 and a second C-leg 37, which are connected by a connecting web 38 formed generally parallel to the longitudinal axis x. The two C-legs 36, 37 as well as the connecting web 38 exemplarily designed as one piece and materially uniformly therewith span a tool mouth 39, into which a workpiece to be machined by the hand tool 1 can be inserted, for example a pellet or a workpiece to be cut.

The first C-leg 36 has a first tool carrier 40. The second C-leg 37 has a second tool carrier 41. The first tool carrier 40 can here be designed as one integral piece with the first C-leg 36, while the second tool carrier 41 can be displaced into the tool mouth 39 relative to the first tool carrier 40. For example, the second tool carrier 41 can here be hydraulically displaced by the moving part 16 that can be linearly displaced in the basic tool base 2.

With reference to FIG. 3, first is a shown possibility to have additionally or instead an higher air pressure generated by means of a pump or compressor, see reference No. 75. The pump or compressor may be actuated by a separate motor 76. The separate motor 76 can also have a separate battery 79. The air generated in the pump or compressor 75 can flow via a pump return valve 77 and separate air duct 78 into the chamber 18.

Further is shown with reference to FIGS. 3a and 3b a possibility to have an independent operating part 80. The operating part 80 can be a piston, specifically an air piston. The piston can be biased into its starting position by a return spring 81. By this configuration, no additional air is delivered into the chamber 18 but rather the chamber 18 is only changed in its volume by moving the air piston. The air piston is a part of the wall of the chamber.

For example, each of the two tool carriers 40, 41 is used to detachably incorporate a tool, wherein the first tool carrier 40 carries a first tool, and the second tool carrier 41 a second tool.

The working head 9 can also have a first tool 42, which while fastened to the tool carrier 27 of the moving part 16 can be linearly displaced inside of the working head 9 along the longitudinal axis x. The first tool 42 can be designed as a displaceable blade, which can be moved in the direction toward a fixed tool 43 in the form of a counter-blade while closing the tool mouth 39 (see FIG. 14). The blades become completely overlapped in a final travelling position.

The mentioned second handle 6, see FIG. 14, can be fastened to a working head web 44 that is generally aligned in the direction of the longitudinal axis x, for example via a thread 45.

In particular in hydraulic hand tools, a pneumatic space 72 is given with the described chamber 18 on the air side of the piston-like moving part 16. During the operation of the hand tool 1, i.e., the forward movement of the moving part 16, the volume of the generally closed chamber 18 that forms a spring space is reduced, and the air inside of the pneumatic space 72 is compressed. Pneumatic sensors S of various kinds can be operated with this compressed air during the use and includes at least one electronic pressure sensor 50, see FIG. 5. The pressure sensor 50 can be used to measure the air pressure inside of the chamber 18. The pressure sensor 50 can n be directly arranged on the chamber 18, facing the interior of the chamber 18. A potentially downstream electronic evaluation and/or control unit can trigger or prevent functions in the hand tool 1, depending on the measuring result.

During the displacement of the moving part from the movement start position in the direction toward the movement end position, but also additionally or alternatively possibly during the displacement of the moving part from the movement end position back in the direction toward the movement start position, a change in air pressure may arise in the chamber. By evaluating the actual air pressure, preferably as a function of at least one stored target air pressure, knowledge can be gained about the state, for example the functionality, of the hand tool. Furthermore, such comparisons with stored target values can also take place during the displacement of the hand tool in various moving part positions. The stored target air pressure can be stored in an electronic memory for example provided for on a platine within the tool.

An evaluation of the air pressure change in the chamber can result in an adjusted display for the user. In the simplest form, this can be an indicator which becomes visible to the user during the change in air pressure. For example, an analog or digital display 74 can further be provided, which possibly displays only two possible states, or also any change in air pressure, for example given a digital pressure value display. Other optical and/or acoustic signals can potentially also be triggered additionally or instead as a function of a change in air pressure.

Such a chamber 18 can also be used in a hand tool 1 having the spindle drive 31 according to FIG. 18 for a pressure measurement.

In a pincer-like hand tool 1 to be operated exclusively manually according to FIGS. 19 and 20, the generally closed chamber 18 can only arise during tool actuation, if necessary.

The various sensors S can be formed by sealable openings 51. These openings 51 are each connected with the pressure sensor 50 via airways 52, wherein the pressure sensor 50 can advantageously be arranged on a circuit board 53, for example one that also has a device controller. The circuit board 53 can preferably be provided in the first handle 5.

For example, the evaluation and/or control unit can be placed on the circuit board 53, as can a potentially provided memory for storing measured air pressure data.

In a configuration of the hand tool 1 according to FIG. 16, the pressure sensor 50 arranged on the circuit board 53 can be provided in the separate actuator 7, for which purpose, aside from the hydraulic hose 8, a channel-like sensor line 73 can be formed between the pressure sensor 50 and the chamber 18 formed in the hand tool 1.

The airways 52 can be formed by airtightly connected hoses 55, which in particular extend inside of the tool housing. Additional airways 52 are formed by open channels 56 of the working head 9 or the tool holder 64 and/or the tool 1 and/or the moving part 16 and/or the adapter 10, wherein gaskets 54 can be interspersed to allow these channels 56 to also bridge interfaces between two sections that can potentially be moved, in particular rotated, relative to each other, for example between a working head 9 or a tool holder 64 and the adapter 10. Furthermore, these channels 56 can transition into hoses 55 inside of the housing.

Several channels 56 and/or hoses 55 for monitoring several sensors S can be connected with each other, so that only one airway 52 ultimately leads directly to the pressure sensor 50.

Initially described based in FIGS. 1 to 3 is an exemplary embodiment in which, in the area of a fork leg 48, the working head 9 which incorporates the pair of compression jaws 22 has a channel 56 for forming an airway 52 that runs generally in the direction of the longitudinal axis x. As shown, this channel 56 can be composed of two or more merging channel sections.

The channel 56 crosses a borehole 47 that is covered by the free end of the bolt 46 in the holding position, and freely opens in a front area of the fork leg 48. The opening 51 that forms the sensor S arises in the covered area of the channel 56 and borehole 47.

As shown, the area of the opening 51 can have a sealing collar 60 therein that reduces the opening surface of the opening 51.

The cylindrical wall forming the chamber 18 is enclosed by a collar 57, which is spaced radially part from the cylindrical wall forming the chamber 18 to leave a tubular channel section 58 therebetween. This channel section 58 is connected with the channel 56 of the working head 9 to form a seal to the environment.

The channel section 58 can transition into a tube section 59, which in turn can be connected to a hose 55 leading to the pressure sensor 50.

The interior of the chamber 18 is connected via a branch channel 61 with the airway 52, here with the channel 56, so that an air pressure that arises in the chamber 18 with the opening 51 sealed also arises in the entire airway network.

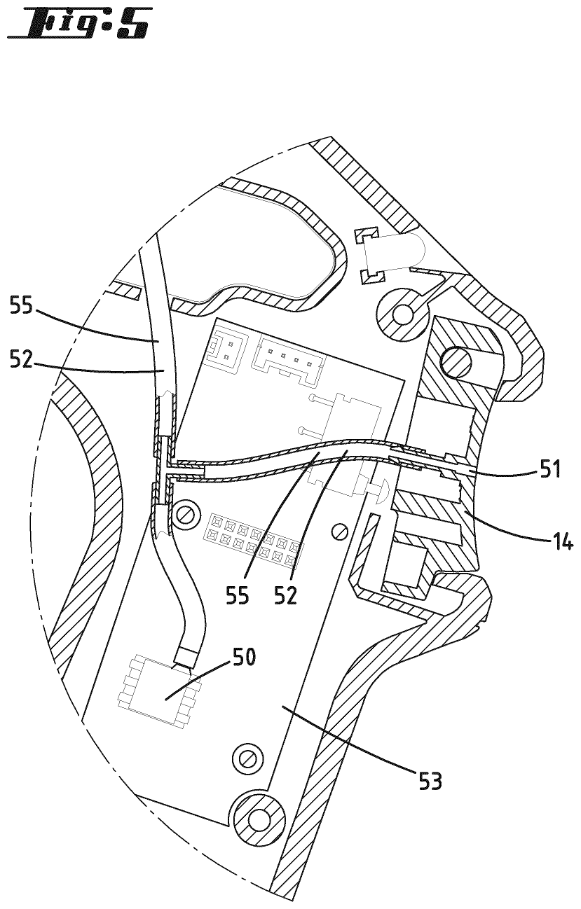

The active principle is clarified based upon the schematic illustrations in FIGS. 6 to 8. The bolt 46 completely introduced into the borehole 47 seals the airway 52 formed by the channel 56 from the environment. The sealing collar 60 sitting in the opening 51 seals the opening 51 by abutting against the surface of the bolt 46.

When the actuator is activated, for example when the electric motor is activated or a hand lever is actuated according to the embodiment in FIG. 17, the pump conveys oil into the pneumatic space 72 of the chamber 18, and moves the moving part 16 forward. This causes the air pressure to rise immediately in the pneumatic space 72 that potentially also accommodates the return spring 17. The rise in air pressure results from the reduction in chamber size.

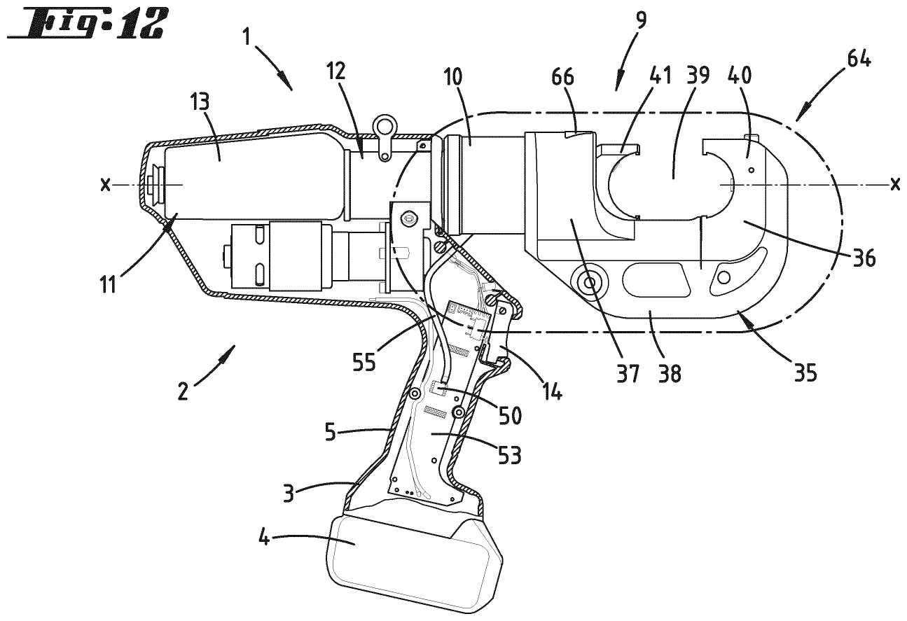

Each stroke of the pump can be visible as a step in the air pressure curve L according to FIG. 9. If the actuator 11 is stopped (point L1 in the air pressure curve L), the moving part 16 no longer moves, and remains in this position. A slight drop in pressure can be caused by imperfect rod and locking pin gaskets.

Opening a return valve (at point L2 of the air pressure curve L) initiates a complete retraction of the moving part 16 caused by a relaxation of the return spring 17, and a complete release of the air pressure. The air pressure can even drop below ambient pressure beforehand owing to a possible loss in pressure resulting from leakage. This behavior is not a disadvantage, since the next operation would then start with a negative pressure, which would be an indicator that the bolt 46 is properly sitting in the holding position even before turning on the motor 32.

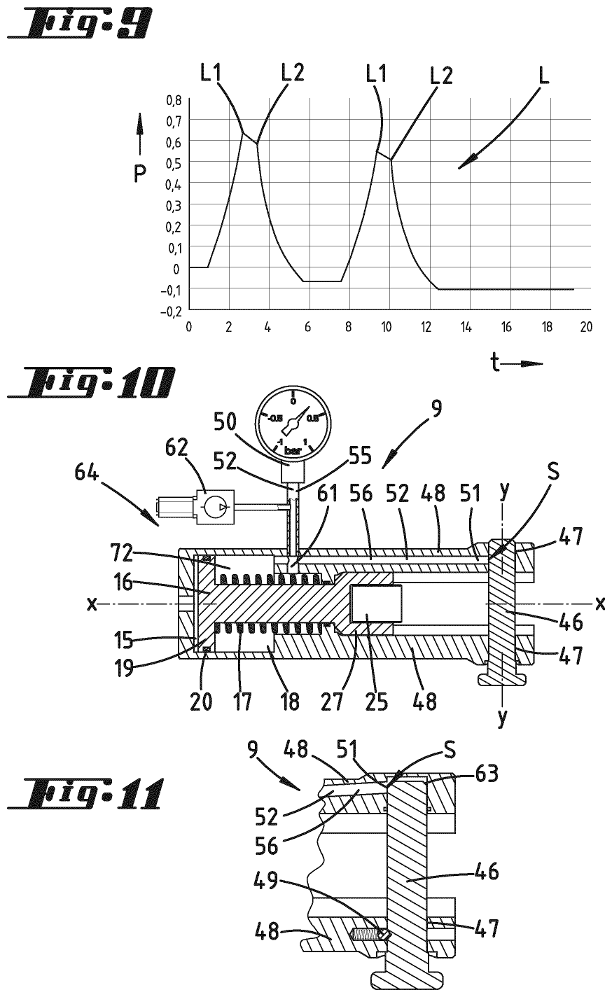

As long as the bolt 46 has been completely introduced, a slight shifting of the moving part 16 already leads to a rise in pressure, which can be precisely measured by the electronic pressure sensor 50. By contrast, if the bolt 46 has not been inserted correctly (as shown in FIG. 8), no rise in pressure takes place due to the opening 51 being open to the environment. This missing signal at the pressure sensor 50 can be used to stop the motor 32 of the hand tool 1 immediately after less than one millimeter of travel, or to prevent an activation of the motor 32. The (further) displacement of the moving part 16 is prevented.

As schematically illustrated in FIG. 10, the pneumatic sensor S can also be activated without an activated movement of the moving part 16 before commissioning the hand tool 1, for example for testing purposes. An auxiliary pump 62 can here be connected, for example in a stationary, idle state of the hand tool 1. This auxiliary pump 62 generates an elevated air pressure in the chamber system of the hand tool 1 by enlarging the total quantity of air enclosed, as long as the bolt 46 remains completely seated in its intended holding position with reference to the first embodiment (as shown in FIG. 10). By contrast, if the bolt 46 is not in its intended holding position, the opening 51 is open to the environment, and no increase in air pressure can be achieved even via the auxiliary pump 62.

Regardless of whether the safety test is performed using the sensors S before or during operation of the hand tool 1, the values measured by the pressure sensor 50 can also be stored in a device memory, for example.

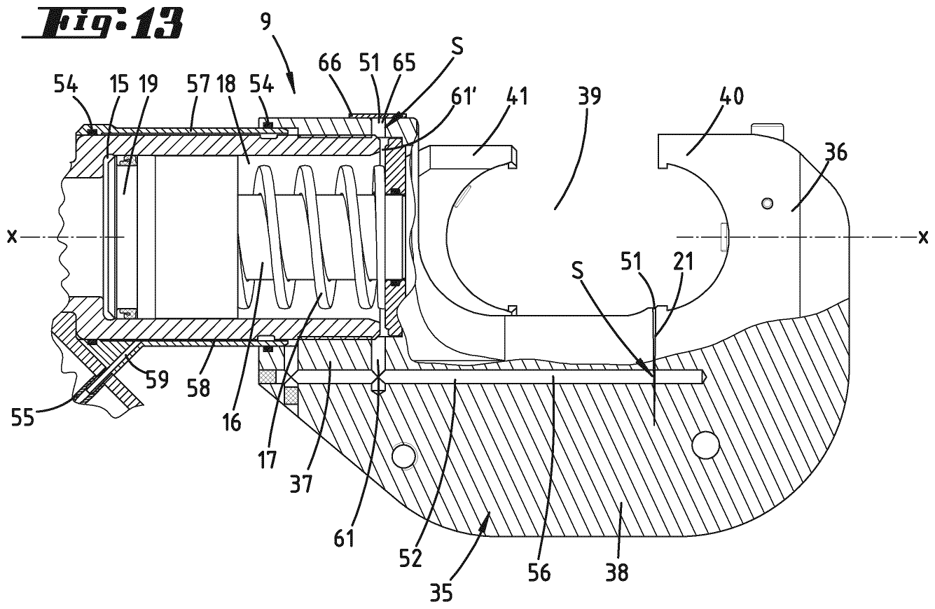

FIG. 11 shows an alternative design of the bolt 46. In the intended holding position, the end of the bolt 46 lying opposite the handling end of the bolt 46 dives into a blind hole-like depression 63, which is provided instead of a borehole 47. A channel 56 that forms an airway 52 opens into this depression 63, and its opening 51 is sealed in the area of the depression 63 by the wall of the bolt 46 with the latter completely inserted. Accordingly, a rise in pressure that can be measured by the pressure sensor 50 arises during a commissioning of the hand tool 1.

As further shown in particular in FIG. 5, an opening 51, forming one of the pneumatic sensors S, is connected with the pressure sensor 50 via an airway 52 in the form of a hose 55 can also be formed in the switch 14 for activating the actuator 11, and covered by the finger of the user which is to actuate the switch 14.

The intended finger arrangement is queried via this pneumatic sensor S. The hand tool 1 can only be activated or further used if an increase in air pressure in the chamber 18 can be reached and acquired by virtue of the opening 51 being covered by the finger.

The pneumatic sensor S on the switch 14 can be combined with the pneumatic sensor S for querying the position of the bolt 46 according to FIGS. 1 to 8, as well as with other sensors S which are also yet to be described below.

According to the exemplary embodiment in FIGS. 12 and 13, a pneumatic sensor S can be set up by forming an airway 52 inside of the working head 9 that comprises the tool holder 64, in particular inside of the connecting web 38, without (initially) resulting in an opening toward the environment.

The formed channel 56 is connected by the branch channel 61 with the interior of the chamber 18, in particular with the pneumatic space 72, as well as with the channel section 58 formed by the collar 57.

In the intended state of the working head 9, a measurable increase in air pressure takes place during the displacement of the moving part 16 and the accompanying reduction in volume of the chamber 18.

A drop in pressure during the operation or no measurable rise in pressure suggests that there is a crack 21 in the tool holder 64. The crack 21 results in an opening 51 to the environment.

Another branch channel 61′ can open into an opening 51 that is formed by a housing borehole 65. For example, this opening 51 can be covered by a label 66, further for example by a warning sticker, and thus be closed with the hand tool 1 configured as intended. If a pressure increase arises during the operation, it suggests that the label 66 is arranged as intended. By contrast, if no increase in air pressure is noted after the label 66 has been removed, the actuator 11, for example the electric motor 32, is turned off or further preferably not started up.

A pneumatic sensor S for querying an intended use of the second handle 6 arranged on the working head 9 can also be provided (see FIG. 14). A channel 56 extending from the chamber 18 through the working head 9 opens in the area of the thread 45 used to fasten the second handle 6 to the working head 9, and in this way is connected with a handle channel 67 in the second handle 6. The handle channel 67 opens into an opening 51 that arises in the periphery of the handle wall and is further positioned in such a way that, during conventional handling, the opening 51 is covered by the hand gripping the second handle 6. By contrast, if the opening 51 is not covered, no increase in pressure takes place. This is regarded as a non-intended use of the hand tool 1.

Given a combination of several pneumatic sensors S, a commissioning of the tool 1 or continued operation of the tool 1 is only enabled if all relevant openings 51 have been sealed, so as to thereby permit an increase in pressure. For example, an intended use state can be present if an opening 51 is covered by a label 66 and/or no crack arises inside of the tool holder 64 and/or if the second handle 6 is gripped as intended and/or the switch 14 is actuated by a finger.

FIG. 18 shows an example with a spindle drive 31. A rise in air pressure in the chamber 18 measured by the pressure sensor 50 can be achieved by covering an opening 51 provided in a gripping area 68 with the hand of the user. If the opening 51 is not covered, no increase in pressure takes place, which is regarded as a non-intended use of the hand tool 1 and leads to a deactivation.

In particular in the case of an electric motor 32 and/or hydraulically or pneumatically driven hand tool 1, the absence of any significant pressure rise can immediately stop the moving part 16 from advancing and/or directly initiate its return, or prevent the advance from starting.

The air pressure achievable in the chamber 18 and the airway system connected thereto is comparatively low, in any event so low as to be inadequate for the necessary force to develop in the area of the tools. The achievable air pressure also does not contribute to force development.

In a pincer-like hand tool 1 according to FIGS. 19 and 20, the moving part 16 can be fixedly connected with the handgrip 29 that serves as the actuator 11. During the operation in which the handgrips 29 and 30 are moved toward each other like pincers, the moving part 16 dives into the chamber 18, which is formed in the other handgrip 30 and connected via an airway 52 in the form of a channel 56 with an opening 51 formed on the surface of the handgrip 30. This opening 51 is covered by a label 66 with the hand tool 1 in the intended operating state.

As the handgrips 29 and 30 move toward each other, the pressing mouth 23 simultaneously closes, and the moving part 16 dives into the chamber 18. This results in a continuous decrease of the volume in the chamber 18, and as a result, a pressure increase arises in the chamber 18 when the opening 51 is covered by the label 66. This can be used to move a visual indicator 70 via another airway 69, which at a corresponding air pressure via a sealed opening 71 protrudes over the surrounding surface of the handgrip 30, and thereby shows the intended use.

By contrast, if the opening 51 is not covered by a label 66, no increase in air pressure takes place. Accordingly, the indicator 70 does not come out.

The cover-sealable openings 51 in the embodiments described above can alternatively also be provided by valves.

REFERENCE LIST

| | |
|---|---|
| 1 | Hand tool |
| 2 | Basic tool base |
| 3 | End piece |
| 4 | Accumulator |
| 5 | Handle |
| 6 | Second handle |
| 7 | Actuator |
| 8 | Hydraulic hose |
| 9 | Working head |
| 10 | Adapter |
| 11 | Actuator |
| 12 | Hydraulic actuator |
| 13 | Hydraulic tank |
| 14 | Switch |
| 15 | Hydraulic space |
| 16 | Moving part |
| 17 | Return spring |
| 18 | Chamber |
| 19 | Piston section |
| 20 | Radial gasket |
| 21 | Crack |
| 22 | Compression jaw pair |
| 23 | Pressing mouth |
| 24 | Pellet |
| 25 | Impact roller |
| 26 | Running surface |
| 27 | Tool carrier |
| 29 | Handgrip |
| 30 | Handgrip |
| 31 | Spindle drive |
| 32 | Electric motor |
| 33 | Hinge formation |
| 34 | Pressing jaw |
| 35 | Holding body |
| 36 | C-leg |
| 37 | C-leg |
| 38 | Connecting web |
| 39 | Tool mouth |
| 40 | First tool carrier |
| 41 | Second tool carrier |
| 42 | Tool |
| 43 | Tool |
| 44 | Working head web |
| 45 | Thread |
| 46 | Bolt |
| 47 | Borehole |
| 48 | Fork leg |
| 49 | Latching ball |
| 50 | Pressure sensor |
| 51 | Opening |
| 52 | Airway |
| 53 | Circuit board |
| 54 | Gasket |
| 55 | Hose |
| 56 | Channel |
| 57 | Collar |
| 58 | Channel section |
| 59 | Tube section |
| 60 | Sealing collar |
| 61 | Branch channel |
| 61′ | Branch channel |
| 62 | Auxiliary pump |
| 63 | Depression |
| 64 | Tool holder |
| 65 | Housing borehole |
| 66 | Label |
| 67 | Gripping channel |
| 68 | Gripping area |
| 69 | Airway |
| 70 | Indicator |
| 71 | Opening |
| 72 | Pneumatic space |
| 73 | Sensor line |
| 74 | Digital Display |
| 75 | Pump/Compressor |
| 76 | Motor |
| 77 | Return valve |
| 78 | Air duct |
| 79 | Battery |
| 80 | Operating part |
| 81 | Return spring |
| x | Longitudinal axis |
| y | Axis |
| L | Air pressure curve |
| L1 | Point |
| L2 | Point |
| S | Sensor |

1-34. (canceled)

35. A hand tool comprising:
a chamber in which an air volume with an air pressure is configured to be enclosed;
a moving part or an opening part independent of the moving part; and
an actuator configured to drive the moving part directly or via a gearbox or by a hydraulic medium configured to perform an intended operation,
wherein the moving part or the opening part is configured to change the air pressure by changing a space of the chamber or by delivering additional air into the chamber, wherein the air pressure is evaluated for identifying a state of the hand tool, and wherein driving of the moving part is performed with or without making use of the air pressure.

36. The hand tool according to claim 35, wherein
the intended operation of the hand tool is performable independently of the air pressure potentially generated in the chamber while performing the intended operation; and/or
a pressure sensor is provided, the pressure sensor being configured to measure the air pressure in the chamber, and that a measured air pressure can be evaluated for detecting the state of the hand tool; and/or
the chamber has a sealable opening, the opening being connected with the chamber via an airway, the hand tool further comprising a tool which is displaceable into a secured position by a bolt that is configured to be moved from an opening position in which the tool can be inserted into the hand tool, into a holding position in which the tool is secured in the hand tool and the opening is sealable by displacing the bolt into the holding position; and/or
a first handle of the hand tool has a finger-actuated switch, the switch has the opening for the air to pass through and the opening that is sealable by a finger that actuates the switch; and/or
a separately applied label is provided, an opening or air to pass through is formed below the label, the opening is sealed by the label, the air pressure is configured to be raised by sealing the opening and an increase in pressure can be regarded as the label being present; and/or
a first handle and a second handle are provided, a chamber in both handles opens into a respective opening arranged in an area of the respective handle that is respectively gripped by a hand during actuation of the hand tool and the air pressure can be raised by sealing both openings; and/or
a tool holder made out of a metal material is provided, the tool holder has an airway formed by the metal material itself, the airway is connected with the chamber and a drop in pressure indicates a crack in the tool holder.

37. The hand tool according to claim 36, wherein the space of the chamber is changed by moving a wall of the chamber.

38. The hand tool according to claim 35, wherein a change in the air pressure can be generated by delivering additional air into the chamber.

39. The hand tool according to claim 38, wherein the change of the air pressure is coupled to the intended operation.

40. A hand tool comprising:
a chamber in which an air volume with an air pressure is configured to be enclosed;
a moving part; and
an actuator configured to drive the moving part directly or via a gearbox or by a hydraulic medium configured to perform an intended operation,
wherein the air pressure is configured to be changed and evaluated for acquiring a state of the hand tool, wherein the intended operation can be performed independently of the air pressure that arises in the chamber.

41. The hand tool according to claim 40, further comprising
a pressure sensor configured to measure the air pressure in the chamber, and that a measured air pressure can be evaluated for acquiring the state of the hand tool; and/or
a change in the air pressure can be generated by changing a size of the chamber; and/or
the change in the air pressure can be generated by changing a quantity of air enclosed in the chamber; and/or
the change in air pressure arises when the intended operation is triggered or performed; and/or
the chamber has a sealable opening, the opening being connected with the chamber via an airway; and/or
the hand tool has a tool that can be displaced into a secured position by a bolt, which bolt can be moved from an opening position, in which the tool can be inserted into the hand tool, into a holding position, in which the tool is secured in the hand tool and wherein the opening can be sealed by displacing the bolt into the holding position; and/or
a first handle of the hand tool has a finger-actuated switch, the switch has the opening for the air to pass through and wherein the air pressure can be increased by sealing the opening in the switch; and/or
the hand tool is provided with a separately applied label and the opening is sealed by the label.

42. The hand tool according to claim 41, wherein the air pressure can be raised by displacing the bolt into the holding position.

43. The hand tool according to claim 41, wherein the increase in air pressure in the chamber can be regarded as a displacement of the bolt into the holding position.

44. The hand tool according to claim 41, wherein the increase in pressure can be regarded as an actuation of the switch by a finger.

45. The hand tool according to claim 41, wherein the opening for air to pass through is formed below the label.

46. The hand tool according to claim 41, wherein an increase of air pressure can be reached by sealing the opening, wherein the increase in pressure can be regarded as the label being present.

47. The hand tool according to claim 41, wherein the hand tool has a second handle.

48. The hand tool according to claim 47, wherein the chamber in both handles opens into a respective opening arranged in an area of the respective handle that is respectively gripped by a hand during actuation of the hand tool.

49. The hand tool according to claim 48, wherein the air pressure can be raised by sealing both openings.

50. The hand tool according to claim 49, wherein the increase in pressure can be regarded as the second handle having been gripped by one hand accompanied by the switch having been actuated by a finger.

51. The hand tool according to claim 41, wherein the hand tool is provided with a tool holder made out of a metal material.

52. The hand tool according to claim 51, wherein the tool holder has an airway formed by the metal material itself.

53. The hand tool according to claim 52, wherein the airway is connected with the chamber.

54. The hand tool according to claim 53, wherein a drop in pressure indicates a crack in the tool holder.
